(19) United States
(12) Patent Application Publication
(10) Pub. No.: US 2011/0159466 A1
(43) Pub. Date: Jun. 30, 2011

(54) DOUBLE-FUNCTION PICTORIAL INSTRUCTION METHOD FOR CHINESE PHONETIC CURSIVE SYMBOL

(76) Inventor: Cheng-Ta Chia, Taipei County (TW)

(21) Appl. No.: 12/647,551

(22) Filed: Dec. 28, 2009

(51) Int. Cl. G09B 19/06

(52) U.S. Cl. 434/157

(57) ABSTRACT

A double-function pictorial instruction method for Chinese phonetic cursive symbol is an instruction system using transforming pattern of English alphabets to teach both the pronunciation and writing of Chinese phonetic symbol. Through transforming English alphabets into patterns similar to Chinese phonetic symbols, people capable of reading English will learn to read the Chinese phonetic symbols while seeing the symbols through the learning system.

### FIELD OF THE INVENTION

The present invention relates to instruction system, and particular to a double-function pictorial instruction system for Chinese phonetic cursive symbol.

### DESCRIPTION OF THE PRIOR ART

Nowadays, Chinese has become a popular language. There are more and more people learn Chinese. Chinese characters are always been fancied by western world which are printed on clothes or tattooed on human bodies.

Not only business men doing trade with China learn Chinese, also schools are gathering resource of Chinese instruction to follow the tide of learning Chinese.

The common way to learn Chinese is to pronounce Chinese characters in English phonetic symbols and to learn Chinese characters further.

Such pronunciation is not as precisely as the Chinese phonetic symbol system.

The Chinese phonetic symbol is used to show pronunciations of Chinese characters in traditional Chinese system. Materials having Chinese phonetic symbols to each Chinese character are effective learning tools to students who want to learn Chinese.

However, the origin Chinese phonetic symbol does not have cursive, the print hand of Chinese phonetic symbol looks like component of Chinese character and it is not similar to English alphabet. Student has to memorize the pronunciation and the writing of the Chinese phonetic symbol before learning pronunciation of combination of consonant and vowel by an instructor. Such long and complex learning of Chinese phonetic symbol is not friendly to students all over the world.

Therefore, to pronounce Chinese characters by English phonetic symbols is not enough for Chinese language instruction. To memorize the pronunciations and writing of all the 37 Chinese phonetic symbols also needs a better way to approach.

### SUMMARY OF THE PRESENT INVENTION

Accordingly, the primary object of the present invention is to provide a double-function pictorial instruction method for Chinese phonetic cursive symbol. Student can learn the Chinese phonetic symbols by cursives of Chinese phonetic symbol which are similar to English alphabets. Student can also pronounce the symbols intuitional through the cursives. The learning will become more efficiently and people can use Chinese phonetic symbol to learn to speak Chinese exactly and straightly.

To achieve above subject, the present invention includes the following steps:

(A) To write down all Chinese phonetic symbols.

(B) To separate the symbols into consonants and vowels.

(C) To pronounce the symbol by English phonetic alphabets.

(D) To transform the English alphabets into patterns as transforming patterns represent specific Chinese phonetic symbol.

(E) To simplify and transform the transforming pattern into cursive of Chinese phonetic symbol.

(F) To write the transforming pattern and the cursive side by side and to pronounce each cursive through the transforming pattern.

(G) To learn to pronounce all the combination of consonants and vowels by the way of step (F).

The present invention also includes a step (H) which is to add a tone mark symbol of [symbol] and [symbol] to a upper right of the phonetic symbol to represent 2nd, 3^{rd}, and 4^{th} tone or a “\dot{}” on a top of the phonetic symbol to represent a 5^{th} tone so as to teach the pronunciations of the tones.

Through the present invention, the pronunciation of the Chinese phonetic symbol is a directly response for the visual image of English alphabet, the writing of the symbol is also easy to learn as well. Therefore, the learning time is shortened and the learning effect is raised.

### BRIEF DESCRIPTION OF THE DRAWINGS

FIG. 1 is a flow chart of a double-function pictorial instruction method for Chinese phonetic cursive symbol of the present invention.

FIG. 2 is a table showing consonants of Chinese phonetic symbol.

FIG. 3 is a table showing vowels of Chinese phonetic symbol.

FIG. 4 is a table showing cursives of the consonants of Chinese phonetic symbol of the present invention.

FIG. 5 is a table showing cursives of the vowels of Chinese phonetic symbol of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

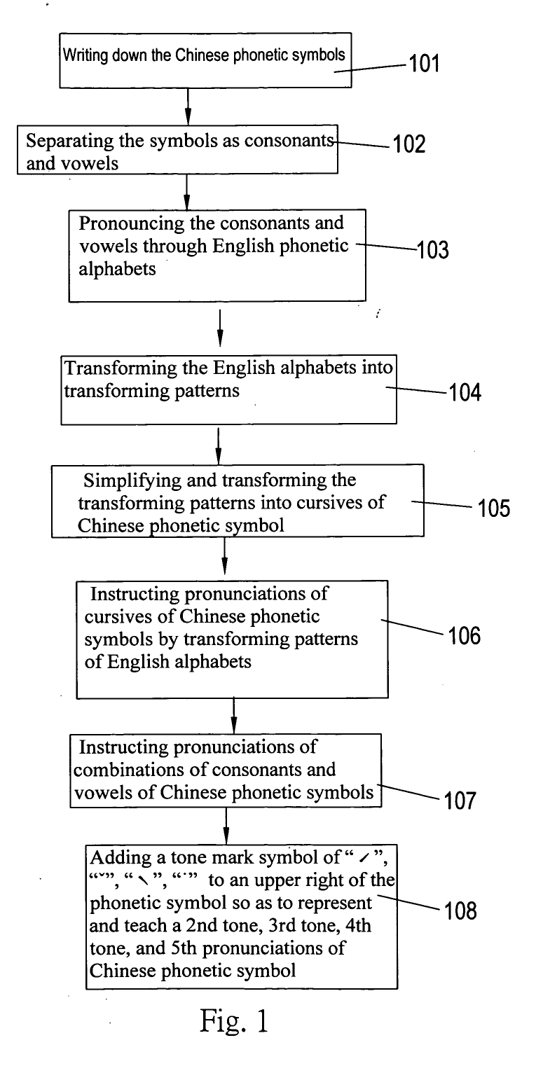

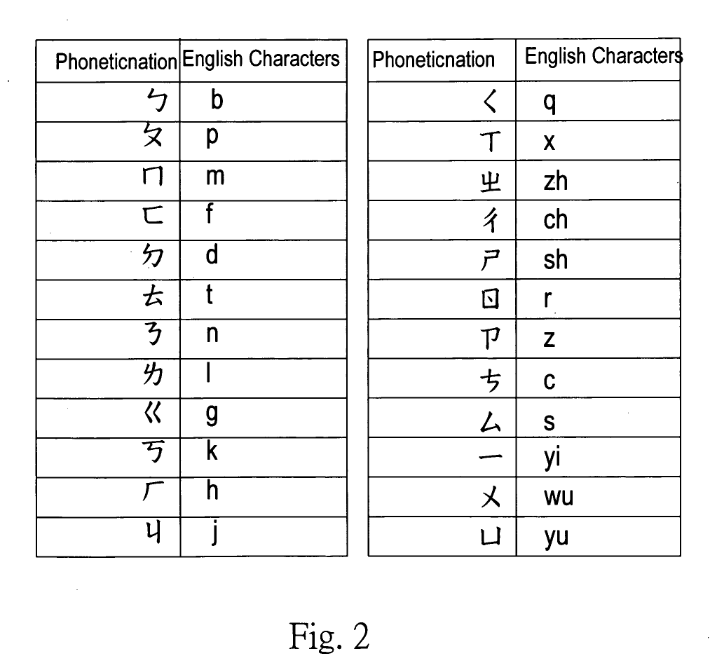

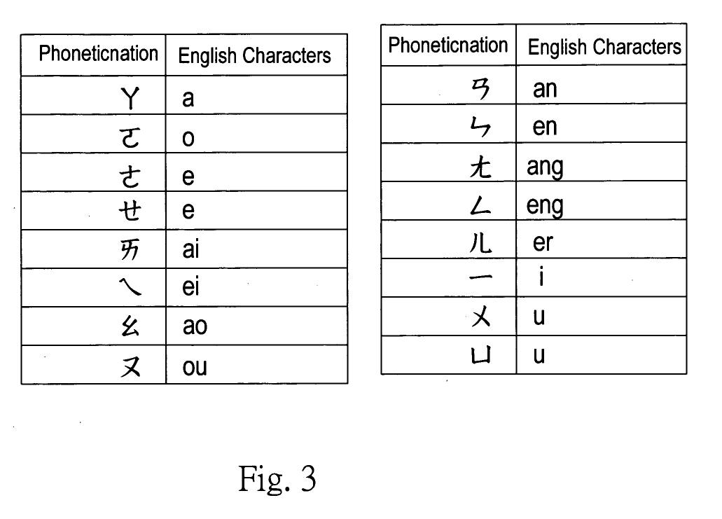

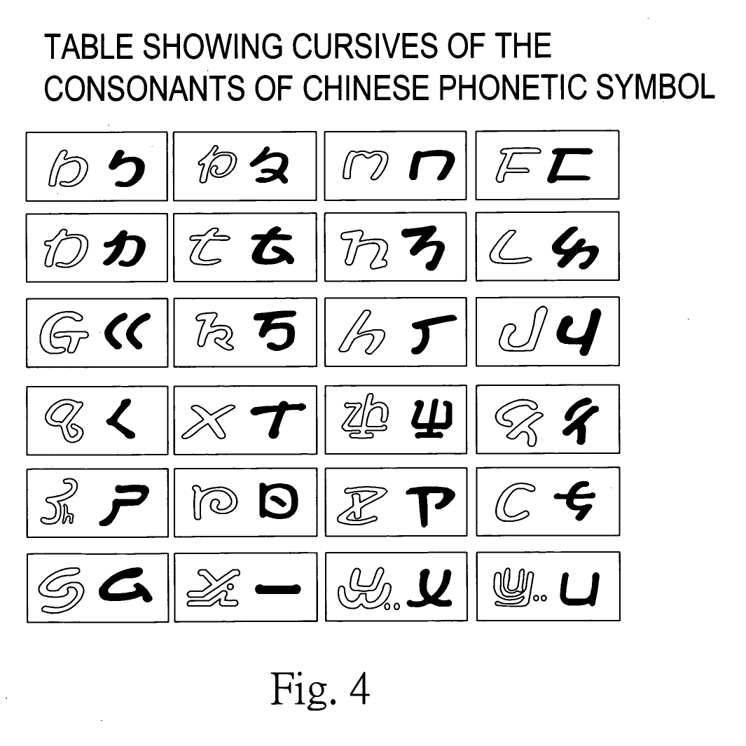

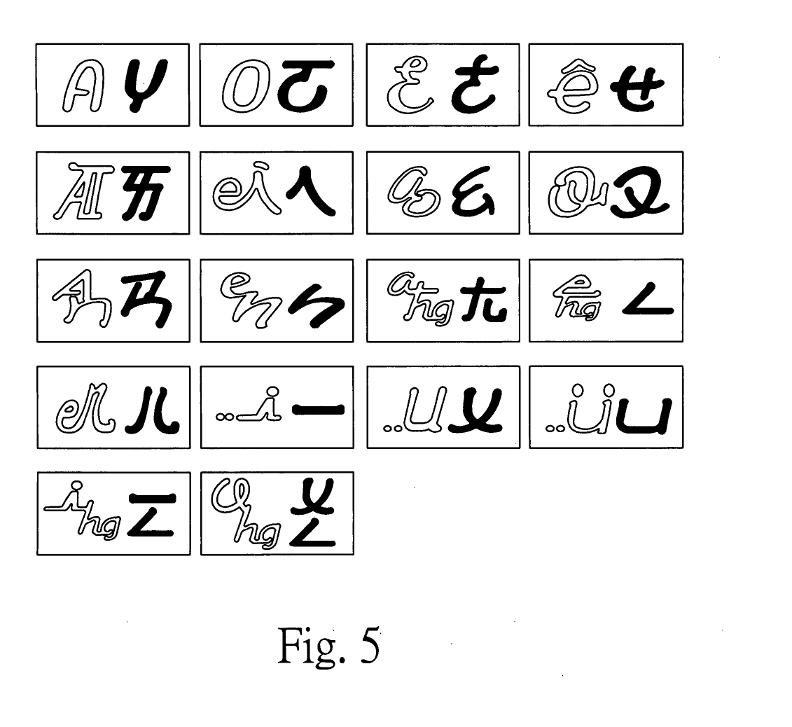

With reference to FIGS. 1 to 5, FIG. 1 is a flow chart of a double-function pictorial instruction method for Chinese phonetic cursive symbol of the present invention. FIG. 2 is a table showing consonants of Chinese phonetic symbol. FIG. 3 is a table showing vowels of Chinese phonetic symbol. FIG. 4 is a table showing cursives of the consonants of Chinese phonetic symbol of the present invention. FIG. 5 is a table showing cursives of the vowels of Chinese phonetic symbol of the present invention.

Referring to FIG. 1. a flow chart of the instruction method of the present invention is illustrated, an instructor writes down all Chinese phonetic symbols in an order from [symbol] to [symbol] (step 101) and separates the symbols as consonants and vowels as shown in FIGS. 2 and 3 (step 102).

Pronunciation of each consonant and vowel are shown in English alphabets by the instructor (step 103). For example, the first symbols [symbol] of the Chinese phonetic symbol is pronounced as English alphabet b. The cursive of b is written by the instructor to represent the phonetic symbol. The present invention is a learning method for English native speaker so that student will immediately know the pronunciation of b as well as the pronunciation of [symbol] . Furthermore, the present invention also transforms the cursive of English alphabet representing the Chinese phonetic symbols as shown in FIGS. 4 and 5 to help student learning and memorizing the symbols.

After the instructor writes down the b in the step 103 mentioned above, the instructor will transform the alphabet into a pattern [symbol] which looks like the Chinese phonetic symbol (step 104). By the shape and writing of the pattern, the instructor will simplify and transform the pattern into a cursive of the Chinese phonetic symbol [symbol] (step 105). By writing the pattern [symbol] and cursive symbol [symbol] side by side, the instructor will teach the pronunciation of the cursive symbol [symbol] through the pronunciation of the pattern [symbol] (step 106). For the similarity of the cursive symbol [symbol] and the pattern [symbol] , student will learn the pronunciation fast. By the transformation of the pattern and cursive symbol of the English alphabet and Chinese phonetic symbol, student will learn print hands of the Chinese phonetic symbols as well as the pronunciations of the Chinese phonetic symbols.

Besides, some phonetic symbols are combined by multiple English alphabets, the instructor will also transform the alphabets into similar pattern to the Chinese phonetic symbol in step 104. For example, the pronunciation of Chinese phonetic symbol [symbol] is similar to “An”. The instructor will transform “An” into a pattern [symbol] , and then simplify the [symbol] into a cursive symbol [symbol] . By writing the pattern [symbol] and cursive symbol [symbol] side by side, student will learn print hand of the Chinese phonetic symbol [symbol] as well as the pronunciations of the Chinese phonetic symbols.

The consonant [symbol] and vowel [symbol] are described above as samples, the rest symbols will follow the same way and will not be described in the following.

After student learns the pronunciations of all phonetic symbols, the instructor will teach different combinations of consonants and vowels and the pronunciations of the combinations (step 107). For example, the combination of the consonant [symbol] and vowel [symbol] is [symbol] so that the pattern [symbol] will be shown by the instructor. Student will learn all the Chinese pronunciations of combinations of consonants and vowels.

Through the transforming pattern and corresponding cursive, the student will learn the pronunciation of the Chinese phonetic symbol and the print hand of the symbol at the same time. After the student learns all the pronunciation completely, the instructor will add a tone mark symbol of [symbol] and [symbol] to a upper right of the phonetic symbol to represent 2nd, 3^{rd}, and 4^{th} tone or a “\dot{}” on a top of the phonetic symbol to represent a 5^{th} tone (step 108) so as to teach the pronunciations of the tones.

Through above learning method for Chinese phonetic symbol, the student will know the pronunciation of Chinese phonetic symbol through English pronunciation. After the student knows the cursive of the Chinese phonetic symbol, the student will have ability of reading books having print hand phonetic symbols marked so as to learn traditional Chinese characters further.

In the present invention, most transforming patterns of the Chinese phonetic symbols are similar to English alphabets, the student will easily associate the pronunciations through it so that the learning of Chinese phonetic symbol becomes more easier.

Through above learning method for Chinese phonetic symbols, the student will know the pronunciation of Chinese phonetic symbol through English pronunciation. After the student knows the cursive of the Chinese phonetic symbol, the student will have ability of reading books having print hand phonetic symbols marked.

Through transforming pattern of English alphabets having similar pronunciation to Chinese phonetic symbols, the student will learn the cursives and the pronunciations of Chinese phonetic symbols very soon without forced memorizing the symbols. Therefore, the learning time is shortened and the learning effect is raised so that the student is capable of reading books or newspapers marked with Chinese phonetic symbols in a short time.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A double-function pictorial instruction method for Chinese phonetic cursive symbol comprising:
(A) writing down the Chinese phonetic symbols;
(B) separating the symbols as consonants and vowels;
(C) pronouncing the consonants and vowels through English phonetic alphabets;
(D) transforming the English alphabets into transforming patterns;
(E) simplifying and transforming the transforming patterns into cursives of Chinese phonetic symbol;
(F) instructing pronunciations of cursives of Chinese phonetic symbols by transforming patterns of English alphabets; and
(G) instructing pronunciations of combinations of consonants and vowels of Chinese phonetic symbols.

2. The pictorial learning method for Chinese phonetic symbol cursive as claimed in claim 1, wherein a tone mark symbol of [symbol] is added to an upper right of the phonetic symbol so as to represent and teach a 2^{nd} tone pronunciation of Chinese phonetic symbol.

3. The pictorial learning method for Chinese phonetic symbol cursive as claimed in claim 1, wherein a tone mark symbol of [symbol] is added to an upper right of the phonetic symbol so as to represent and teach a 3^{rd} tone pronunciation of Chinese phonetic symbol.

4. The pictorial learning method for Chinese phonetic symbol cursive as claimed in claim 1, wherein a tone mark symbol of [symbol] is added to an upper right of the phonetic symbol so as to represent and teach a 4^{th} tone pronunciation of Chinese phonetic symbol.

5. The pictorial learning method for Chinese phonetic symbol cursive as claimed in claim 1, wherein a tone mark symbol of “\dot{}” is added to a top of the phonetic symbol so as to represent and teach a 5^{th} tone pronunciation of Chinese phonetic symbol.
